(19) United States
(12) Patent Application Publication
(10) Pub. No.: US 2026/0249581 A1
(43) Pub. Date: Aug. 27, 2026

(54) STACKING MEDIA BIN

(71) Applicant: Cardtronics USA, Inc., Atlanta, GA (US)

(72) Inventor: Neil Sivewright, Dundee (GB)

(21) Appl. No.: 19/065,244

(22) Filed: Feb. 27, 2025

(51) Int. Cl. B31F 1/20; G07D 11/13; G07D 11/16

(52) U.S. Cl. CPC B31F 1/20; G07D 11/13; G07D 11/16; G07D 2211/00

(57) ABSTRACT

A system and technique may be used to stack media in a bin. An example system may include a slot configured to receive media, a set of rollers configured to convey the media from the slot to a bin, and a central roller configured to corrugate the media as it is conveyed by the set of rollers. In some examples, the example system may include a flexible guide strip configured to slow momentum of the media as it enters the bin.

### BACKGROUND

An Automated Teller Machine (ATM) is an electronic banking device that allows customers to perform financial transactions, such as withdrawing cash, checking account balances, and making deposits, without the need for a human bank teller. ATMs are typically connected to financial networks and are commonly located at bank branches, shopping centers, and other convenient public locations to provide easy access to banking services.

### SUMMARY

In various examples, methods and systems for stacking media in a bin are presented.

According to an example, a system includes a slot configured to receive media, a set of rollers configured to convey the media from the slot to a bin, and a central roller configured to corrugate the media as it is conveyed by the set of rollers. The system may include a flexible guide strip configured to slow momentum of the media as it enters the bin. The system may include a bin to hold media, the bin optionally having a counterbalanced platform as a base.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIGS. 1A-1B illustrate various views of internal aspects of a stacking media bin in accordance with some examples.

FIGS. 2A-2B illustrate various views of a back portion of a stacking media bin in accordance with some examples.

FIGS. 3A-3C illustrate various views of a media roller in accordance with some examples.

FIG. 4 illustrates generally a flowchart showing a technique for stacking media in a bin in accordance with some examples.

### DETAILED DESCRIPTION

The systems and techniques described herein provide a stacking media bin that may operate without a motor. Media storage bins store media, such as currency notes or checks in a stack. A media storage bin may compress media to force additional storage space within the media storage bin. Currently, media storage bins require a series of track sensors, stepper motors, and drivetrains to compress the media. However, these components add complexities to the media storage bin, which increases physical space required to accommodate the media stacking bin, has a higher likelihood of failure than the non-motorized media stacking bin described herein, and may have a higher cost.

The non-motorized stacking media storage bin described herein may remove the need for stepper motors, track sensors, positional sensors, or drive-train components while stacking and compressing media at a same or better task functionality and performance as the motorized stacking bins used currently. The reduced number of components of the non-motorized stacking media storage bin described herein may be used to reduce an overall package size of a media handling device allowing for smaller profile automated teller machines (ATMs).

The non-motorized stacking media bin described herein may be used for cash handling storage bins that have horizontal stacking of media, such as an ATM (e.g., SDM2 or SCPM2 manufactured by NCR). The reduced complexity of the non-motorized stacking bin includes a reduced number of components that may result in fewer field errors.

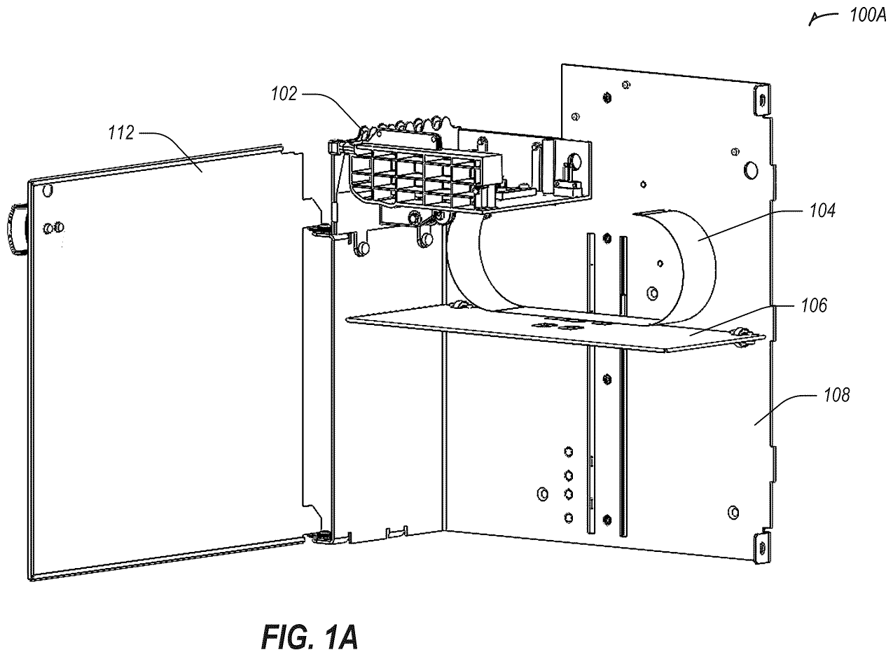

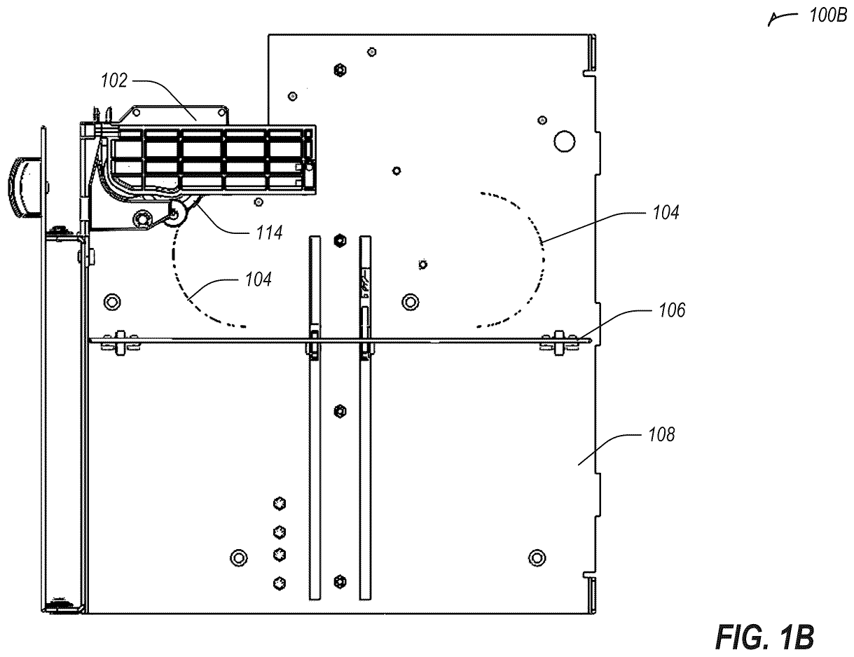

FIGS. 1A-1B illustrate various views 100A-100B of internal aspects of a stacking media bin in accordance with some examples. View 100A shows the stacking media bin in a state where door 112 has been opened. For operation, door 112 may be closed. The stacking media bin includes a corrugating roller assembly 102 that may receive media (e.g., via a slot opening). The corrugating roller assembly 102 may corrugate media as the media is conveyed through the corrugating roller assembly 102 to an internal portion of the media stacking bin. The corrugating roller assembly 102 is described in more detail below.

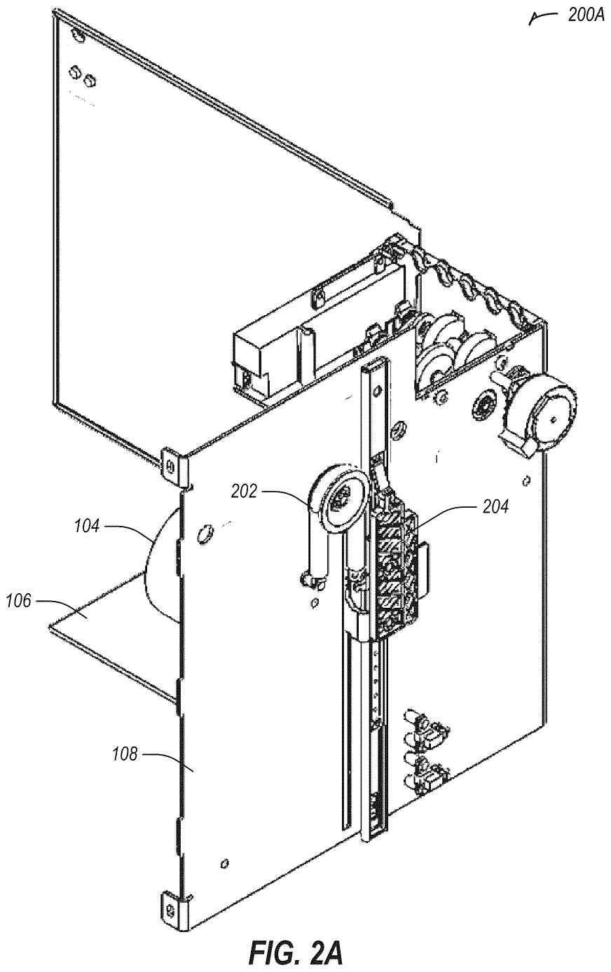

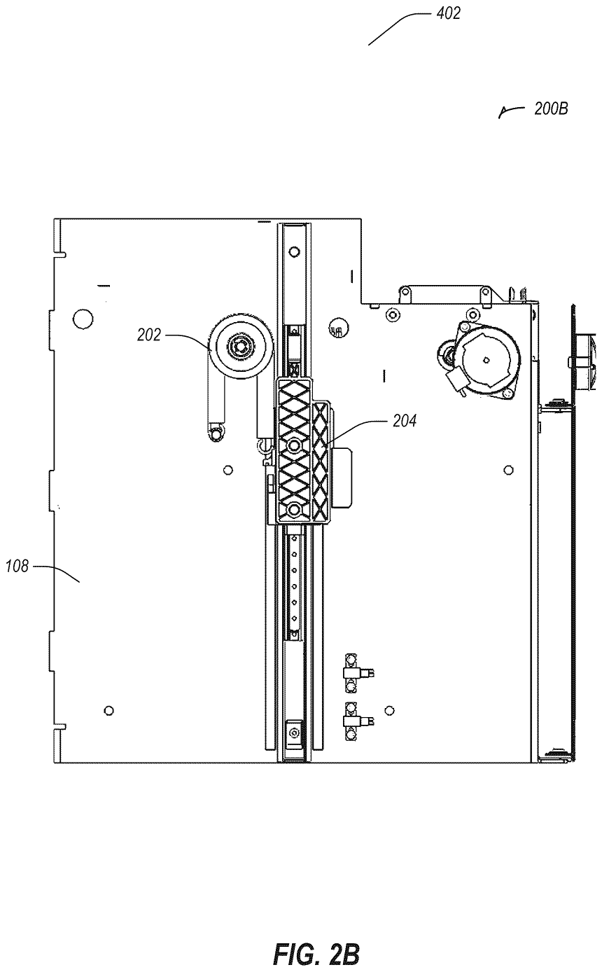

As media is conveyed out of the corrugating roller assembly 102, the media contacts a flexible strip 104, which slows the media as it comes to rest on a platform 106. The flexible strip 104 slows the media via a friction force. In some examples, a back wall (not shown) stops the media from leaving the platform 106. Subsequent media stacks on previously received media on the platform 106. The flexible strip 104 provides a compressive force on any media stacked on the platform 106. The flexible strip 104 may be attached to a back wall 108, for example on a side shown of the back wall 108 in FIG. 1A, or by going through respective slots in the back wall 108 and affixing to an opposite side (e.g., shown in FIG. 2A). Although shown with both ends of the flexible strip 104 attached to the back wall 108, in other examples only one may be attached, one may be attached to a portion of the corrugating roller assembly 102 (e.g., with or without an opposite end attached to the back wall 108), etc.

Street and heavy conditioned media may present issues for efficient media stacking, may cause a jam, or may reduce storage capacity. As media is fed into a bin entry guide, driven rollers of the corrugating media assembly 102 pull the media through one or more rollers. The corrugating media assembly 102 may include a corrugating roller to corrugate the media. The corrugating roller have a large diameter relative to a conveyance roller. By using the corrugating roller, issues in the media may be reduced or a stiffness of the media entering the stacking media bin may be increased.

The corrugated media may follow a path into the stacking media bin guided by the flexible strip 104. The flexible strip 104 may reduce momentum of media being ejected into the stacking media bin. The flexible strip 104 may press the media down to create a stack within the stacking media bin. With each media following a path of the flexible strip 104, next media fed into the stacking media bin lands on top of a previous note and may maintain media stiffness until the media reaches the stack.

The media is stacked on a platform 106. As the media enters the stacking media bin, the mass of the media stack weighs down the platform 106 allowing for more space at the top of the stack. The platform 106 may include a counterbalance as shown in FIG. 2A and discussed below.

View 100B in FIG. 1B shows a side view of the stacking media bin including a corrugating wheel 114. The corrugating wheel 114 may be used to corrugate media as it moves through the corrugating media assembly 102. A drive from a cash handling device (e.g., as media is received at an ATM) may drive a one or more rollers (discussed further below) to pull media through the corrugating media assembly 102, during which the corrugating wheel 114 may cause a corrugation to be made in the media to reduce an impact of any media conditions or to stiffen the media. After being corrugated, the media encounters the flexible strip 104, which dampens the force of the ejected media and may guide the media towards the platform 106. The flexible strip 104 may press the media down on the platform 106 to compress a stack of media. As more media is entered to the bin, each note follows the flexible strip 104 to be placed on top of the previously deposited media. The platform 106 may use a counterbalance, such as an extension spring (discussed further below) to counterbalance the media mass on the platform 106 as it is deposited. This allows for more space to be created at a top of stacking media bin allowing for media to stack at a middle portion of the flexible strip 104.

FIGS. 2A-2B illustrate various views of a back portion of a stacking media bin in accordance with some examples. FIG. 2A illustrates an isometric view 200A of the stacking media bin, with partially visible platform 106 and flexible strip 104. The isometric view 200A includes a back view of the back wall 108 and includes a pulley 202 and a counterweight 204. The pulley 202 may be used to maintain a particular height or range of heights of a topmost piece of media stacked on the platform 106 as media is added to the platform 106. For example, the pulley 202 may be tuned to provide an upward force on the platform 106 to maintain the position of a topmost media item on the platform 106. The counterweight 204 may be used to maintain the position of the platform 106, such as when there is substantial media on the platform 106. FIG. 2B illustrates the stacking media bin in a back view 200B including the back wall 108, the pulley 202, and the counterweight 204.

As media enters the stacking media bin, mass of the media as it stacks drives the platform 106 down. This allows for more space at the top of the stack. For example, the platform 106 may move down while an amount of space between the flexible strip 104 and a topmost piece of media is maintained. As more media enters the bin, each note follows the flexible strip 104 and is placed on top of a previously deposited note. The counterweight 204 may include an extension spring. The counterweight 204 may be used with the pulley 202 to counterbalance media mass as media is deposited.

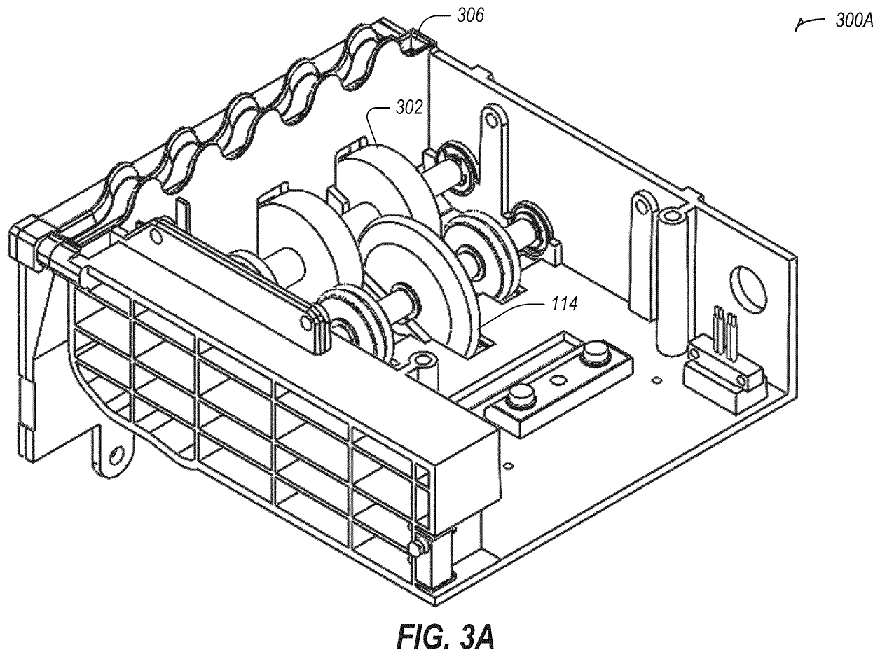

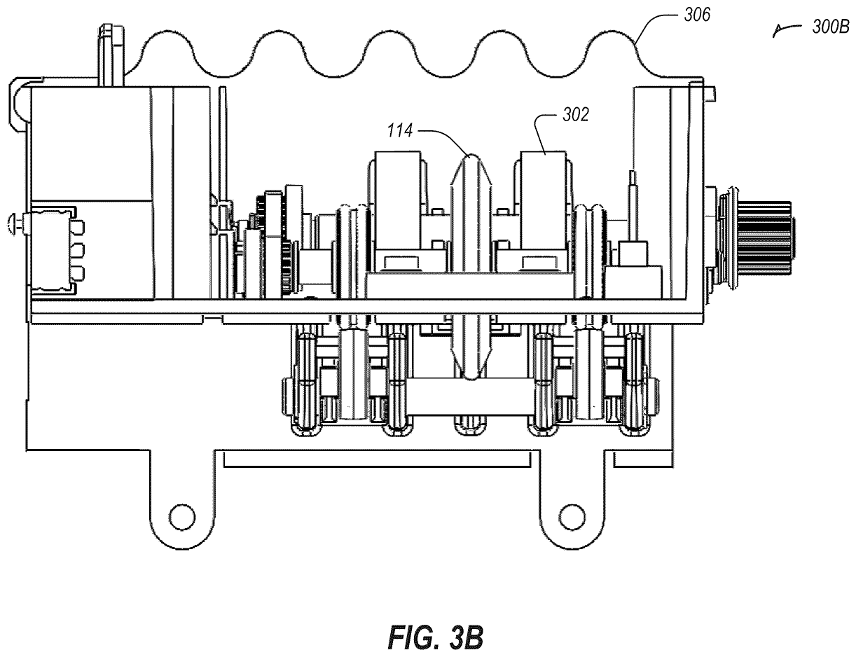

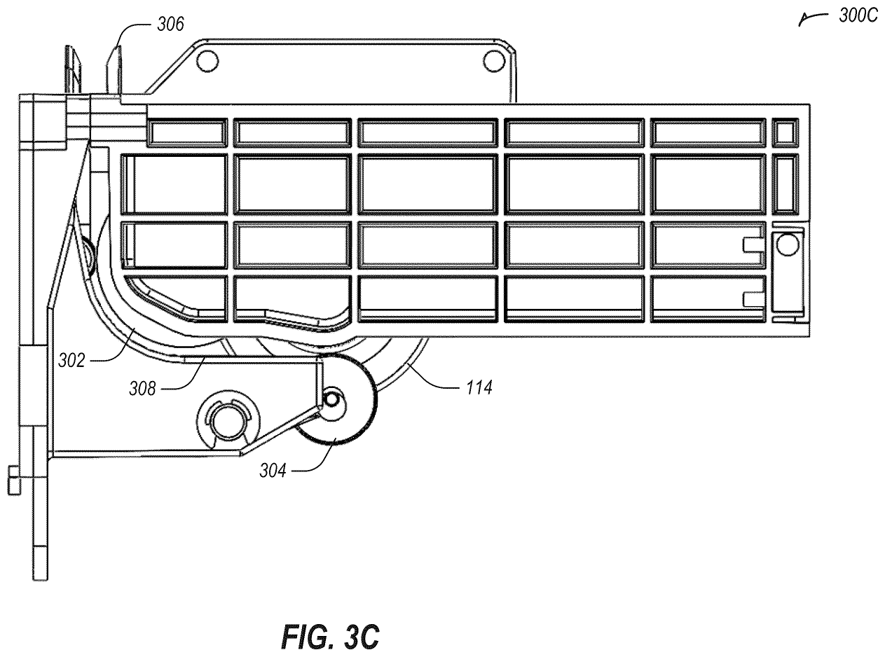

FIGS. 3A-3C illustrate various views of a media roller device in accordance with some examples. FIG. 3A illustrates an isometric view 300A of the media roller device. FIG. 3B illustrates a side view 300B of the media roller device. FIG. 3C illustrates a front view 300C of the media roller device. The various views illustrate a first roller mechanism 302, a second roller mechanism 304, a media slot (e.g., having a slot wall 306), and the corrugating wheel 114.

The media slot leads to a channel defined by a lower ramp 308. Media, when inserted into the media slot is conveyed by the first roller mechanism 302 and the second roller mechanism 304. The first roller mechanism 302 and the second roller mechanism 304 may be used to squeeze media, such as to create a rigidity in the media. The corrugating wheel 114 may be used to introduce a crease into the media as it exits the channel and enters a storage bin portion of a media handling device.

As a note is introduced into the media roller device the note is drawn between the two sets of roller mechanisms 302 and 304, which pinch the note. The corrugating wheel 114 may be a larger roller or roller mechanism (e.g., compared to the first roller mechanism 302 or the second roller mechanism 304, which may differ in size as well), and is used to corrugate the note as it exits the media roller device. Notes inserted into the slot may be rolled up, folded over, crumpled, rippled, bent, curved, etc. By corrugating the note using the corrugating wheel 114, the first roller mechanism 302 and the second roller mechanism 304, these issues are negated allowing for more efficient stacking of notes in the storage bin. A note may have a corrugating feature introduced by the corrugating wheel 114, which may include a U or V shape in the note along the longer axis of the note. A corrugated note, particularly one corrugated along the longer axis of the note may be stiffer than a non-corrugated note, providing for more structural integrity when pushed down by a flexible strip (e.g., the flexible strip 104 of FIG. 1A). The corrugated note may stack more efficiently than a non-corrugated note by having more uniform features with other corrugated notes.

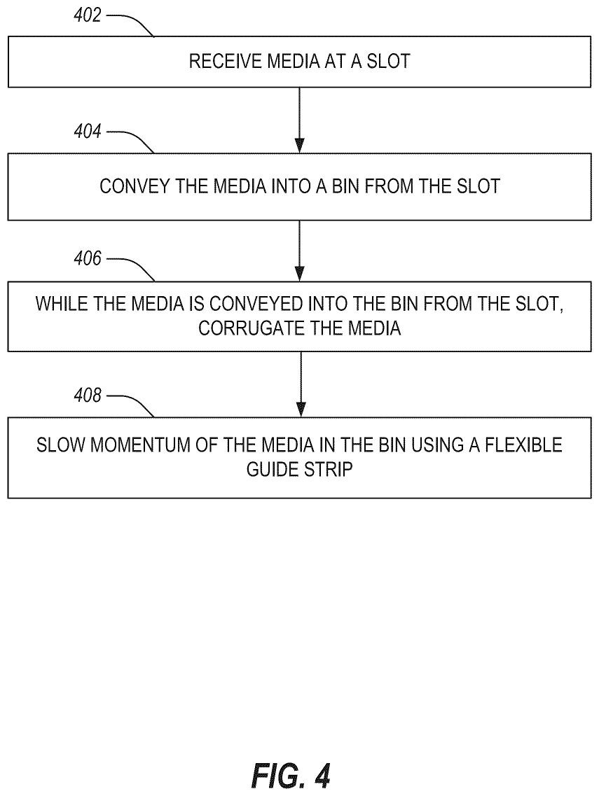

FIG. 4 illustrates generally a flowchart showing a technique 400 for stacking media in a bin in accordance with some examples. The technique 400 includes an operation 402 to receive media at a slot.

The technique 400 includes an operation 404 to convey the media into a bin from the slot. The media may be conveyed using a set of rollers, such as four or six rollers, which may be arranged on opposite sides of a central portion of the media. The set of rollers may be used to pinch the media as it is conveyed into the bin from the slot. The bin may include a counterbalanced platform as a base, the counterbalanced platform configured to be lowered as media is added to the bin. An extension spring may be arranged outside the bin and configured to apply an upward force to the counterbalanced platform.

The technique 400 includes an operation 406 to, while the media is conveyed into the bin from the slot, corrugate the media. The media may be corrugated using a central roller. The central roller may be larger in diameter than any roller used to convey the media.

The technique 400 includes an operation 408 to slow momentum of the media in the bin using a flexible guide strip. In an example, the flexible guide strip is fixed at a top portion of the bin or extends into the top portion of the bin and the flexible guide strip extends downward into the bin from the top portion. The flexible guide strip may be made of a flexible plastic.

Each of these non-limiting examples may stand on its own, or may be combined in various permutations or combinations with one or more of the other examples.
Example 1 is an automated teller machine (ATM) comprising: a slot configured to receive media; a set of rollers configured to convey the media from the slot to a bin; and a central roller configured to corrugate the media as it is conveyed by the set of rollers.
In Example 2, the subject matter of Example 1 includes, wherein the ATM further comprises a flexible guide strip configured to slow momentum of the media as it enters the bin.
In Example 3, the subject matter of Example 2 includes, wherein the flexible guide strip is fixed at a top portion of the bin or extends into the top portion of the bin, and wherein the flexible guide strip extends downward into the bin from the top portion.
In Example 4, the subject matter of Examples 2-3 includes, wherein the flexible guide strip is made of a flexible plastic.
In Example 5, the subject matter of Examples 1-4 includes, wherein the set of rollers includes four or six rollers arranged evenly on opposite sides of the central roller.
In Example 6, the subject matter of Examples 1-5 includes, wherein the central roller is larger in diameter than any roller of the set of rollers.
In Example 7, the subject matter of Examples 1-6 includes, wherein the set of rollers are configured to pinch the media as it is conveyed from the slot to the bin.
In Example 8, the subject matter of Examples 1-7 includes, wherein the ATM further comprises the bin, the bin including a counterbalanced platform as a base, the counterbalanced platform configured to be lowered as media is added to the bin.
In Example 9, the subject matter of Example 8 includes, wherein the ATM further comprises an extension spring arranged outside the bin and configured to apply an upward force to the counterbalanced platform.
Example 10 is a system comprising: a bin to hold media, the bin having a counterbalanced platform as a base; a slot configured to receive the media; a set of rollers configured to convey the media from the slot to the bin; a central roller configured to corrugate the media as it is conveyed by the set of rollers; and a flexible guide strip configured to slow momentum of the media as it enters the bin.
In Example 11, the subject matter of Example 10 includes, wherein the flexible guide strip is configured to apply a downward pressure to the media in the bin.
In Example 12, the subject matter of Examples 10-11 includes, wherein the flexible guide strip is fixed at a top portion of the bin or extends into the top portion of the bin, and wherein the flexible guide strip extends downward into the bin from the top portion.
In Example 13, the subject matter of Examples 10-12 includes, wherein the flexible guide strip is made of a flexible plastic.
In Example 14, the subject matter of Examples 10-13 includes, wherein the set of rollers includes four or six rollers arranged evenly on opposite sides of the central roller.
In Example 15, the subject matter of Examples 10-14 includes, wherein the central roller is larger in diameter than any roller of the set of rollers.
In Example 16, the subject matter of Examples 10-15 includes, wherein the set of rollers are configured to pinch the media as it is conveyed from the slot to the bin.
In Example 17, the subject matter of Examples 10-16 includes, wherein the system further comprises an extension spring arranged outside the bin and configured to apply an upward force to the counterbalanced platform.
Example 18 is a system comprising: a bin to hold media within an automated teller machine (ATM); a slot configured to receive the media from outside the ATM; a set of rollers configured to convey the media from the slot to the bin; and a central roller configured to corrugate the media as it is conveyed by the set of rollers.
In Example 19, the subject matter of Example 18 includes, wherein the system further comprises a flexible guide strip configured to slow momentum of the media as it enters the bin.
In Example 20, the subject matter of Example 19 includes, wherein the flexible guide strip is fixed at a top portion of the bin or extends into the top portion of the bin, and wherein the flexible guide strip extends downward into the bin from the top portion.
Example 21 is at least one machine-readable medium including instructions that, when executed by processing circuitry, cause the processing circuitry to perform operations to implement of any of Examples 1-20.
Example 22 is an apparatus comprising means to implement of any of Examples 1-20.
Example 23 is a system to implement of any of Examples 1-20.
Example 24 is a method to implement of any of Examples 1-20.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

1. An automated teller machine (ATM) comprising:
a slot configured to receive media;
a set of rollers configured to convey the media from the slot to a bin;
a central roller configured to corrugate the media as it is conveyed by the set of rollers; and
a flexible guide strip configured to slow momentum of the media as it enters the bin and to apply a downward pressure to the media in the bin.

2. (canceled)

3. The ATM of claim 1, wherein the flexible guide strip is fixed at a top portion of the bin or extends into the top portion of the bin, and wherein the flexible guide strip extends downward into the bin from the top portion.

4. The ATM of claim 1, wherein the flexible guide strip is made of a flexible plastic.

5. The ATM of claim 1, wherein the set of rollers includes four or six rollers arranged evenly on opposite sides of the central roller.

6. The ATM of claim 1, wherein the central roller is larger in diameter than any roller of the set of rollers.

7. The ATM of claim 1, wherein the set of rollers are configured to pinch the media as it is conveyed from the slot to the bin.

8. The ATM of claim 1, wherein the ATM further comprises the bin, the bin including a counterbalanced platform as a base, the counterbalanced platform configured to be lowered as media is added to the bin.

9. The ATM of claim 8, wherein the ATM further comprises an extension spring arranged outside the bin and configured to apply an upward force to the counterbalanced platform.

10. A system comprising:
a bin to hold media, the bin having a counterbalanced platform as a base;
a slot configured to receive the media;
a set of rollers configured to convey the media from the slot to the bin;
a central roller configured to corrugate the media as it is conveyed by the set of rollers; and
a flexible guide strip configured to slow momentum of the media as it enters the bin and apply a downward pressure to the media in the bin.

11. (canceled)

12. The system of claim 10, wherein the flexible guide strip is fixed at a top portion of the bin or extends into the top portion of the bin, and wherein the flexible guide strip extends downward into the bin from the top portion.

13. The system of claim 10, wherein the flexible guide strip is made of a flexible plastic.

14. The system of claim 10, wherein the set of rollers includes four or six rollers arranged evenly on opposite sides of the central roller.

15. The system of claim 10, wherein the central roller is larger in diameter than any roller of the set of rollers.

16. The system of claim 10, wherein the set of rollers are configured to pinch the media as it is conveyed from the slot to the bin.

17. The system of claim 10, wherein the system further comprises an extension spring arranged outside the bin and configured to apply an upward force to the counterbalanced platform.

18. A system comprising:
a bin to hold media within an automated teller machine (ATM);
a slot configured to receive the media from outside the ATM;
a set of rollers configured to convey the media from the slot to the bin;
a central roller configured to corrugate the media as it is conveyed by the set of rollers; and
a flexible guide strip configured to slow momentum of the media as it enters the bin and to apply a downward pressure to the media in the bin.

19. (canceled)

20. The system of claim 18, wherein the flexible guide strip is fixed at a top portion of the bin or extends into the top portion of the bin, and wherein the flexible guide strip extends downward into the bin from the top portion.
